(19) United States
(12) Patent Application Publication
(10) Pub. No.: US 2026/0131322 A1
(43) Pub. Date: May 14, 2026

(54) REACTOR PYROPHORIC TREATMENT SYSTEM AND METHOD

(71) Applicant: USA DeBusk LLC, Deer Park, TX (US)

(72) Inventor: Blake Montgomery, Lumberton, TX (US)

(21) Appl. No.: 18/947,860

(22) Filed: Nov. 14, 2024

(51) Int. Cl. B01J 38/70; B01J 37/18

(52) U.S. Cl. CPC B01J 38/70; B01J 37/18

(57) ABSTRACT

A technique for treating a reactor that includes taking a reactor offline; clearing the reactor; cooling the reactor; conducting pyrophoric treatment of the reactor, the pyrophoric treatment of the reactor including: providing a buffer-passivation solution; introducing the buffer-passivation solution into the reactor; providing an oxidizer solution; introducing the oxidizer solution into the reactor; draining the reactor of the buffer-passivation solution and the oxidizer solution; and hydrogen gas purging the reactor; cooling the reactor; purging the reactor; and opening the reactor.

### FIELD

Embodiments relate generally to treatment of reactors and more particularly to systems and methods for treatment of pyrophoric substances in reactor systems.

### BACKGROUND

In oil refineries, catalytic processes play a crucial role in converting crude oil into more valuable products. For example, catalytic reforming converts low-octane petroleum naphtha into high-octane reformate, a key gasoline blending component, through a series of chemical reactions. The process includes sulfur removal in a reformer pretreater reactor, followed by the conversion of hydrocarbons into high-octane aromatic compounds. Another common process utilizes catalytic reactors supplied with hydrogen gas (often sourced from the reformers) to remove sulfur and other impurities from crude distillates, producing products such as diesel, heating oil, and kerosene/jet fuel. In these catalytic desulfurization hydrotreating reactors, sulfur is removed in the form of hydrogen sulfide, which can be converted to elemental sulfur. Similarly, hydrocracking employs hydrogen and catalysts to break down heavier crude fractions into lighter, more valuable products. Over time, catalysts in these processes degrade, requiring periodic turnarounds, during which catalytic materials in reactors are regenerated or replaced to maintain efficiency and ensure continued optimal performance in these critical processes.

### SUMMARY

Over time, reactor catalysts accumulate contaminants that reduce their effectiveness, making periodic maintenance necessary to replace, replenish, or regenerate the catalysts. In facilities like oil refineries and chemical plants, this maintenance is carried out during “turnarounds,” when the catalytic materials that are integral to the continuous manufacturing process are refreshed. During these turnarounds, the reactor is taken offline, halting the conversion of incoming feedstock into higher-value catalytically modified products. This stoppage impacts both upstream and downstream processes: the feedstock supply may need to be halted or stored, adding operational complexity and costs, while downstream processes reliant on the reactor's output are idled, incurring significant economic costs. In addition to the economic imperative to minimize downtime during “turnarounds,” a shorter timeline can provide greater flexibility in managing and scheduling them to meet state and federal regulations. These include requirements from the Environmental Protection Agency (EPA) and Occupational Safety and Health Administration (OSHA), which ensure environmental protection and worker safety in the oil and chemical industries. Therefore, minimizing downtime is crucial for cost reduction, and one effective approach is to shorten the turnaround period.

Provided in some embodiments are techniques for treating a reactor, particularly in industrial or catalytic applications, with a focus on enhancing safety and functionality when dealing with pyrophoric materials that can spontaneously ignite upon exposure to air. For example, embodiments of treating a reactor may include taking the reactor offline, disengaging it from its operational state to start the treatment process. The reactor may then be cleared of any remaining substances or residues, preparing it for further steps. Following this, the reactor may be cooled to a suitable temperature for handling and treatment. A pyrophoric treatment may then be performed, which neutralizes pyrophoric materials within the reactor to prevent spontaneous ignition. This can involve introducing a buffer-passivation solution into the reactor, which stabilizes reactive materials. An oxidizer solution may be introduced into the reactor simultaneously with (or shortly after the start of) the introduction of the buffer-passivation solution to further treat and neutralize any remaining reactive substances with a mixture of the buffer-passivation solution and the oxidizer solution. Once the buffer-passivation and oxidizer solutions have completed their function, both may be drained from the reactor. In some instances, such as when passivation is to be performed, the introduction of the oxidizer solution may be terminated, and additional buffer-passivation solution may be introduced thereafter, such that a passivation operation is completed after the introduction of the oxidizer solution. The next step may involve purging the reactor with hydrogen gas to remove any residual materials or reactive substances. The reactor may then be cooled once more to maintain a safe temperature for the final stages of the process. A second purging may be conducted with nitrogen to ensure the complete removal of flammable gases or any remaining substances, and the reactor may be safely opened for inspection or maintenance. Such a technique may provide an efficient and safe process for treating reactors, particularly by neutralizing pyrophoric materials, thereby preventing hazardous reactions during maintenance or cleaning procedures.

Provided in some embodiments is a method of treating a reactor including: taking a reactor offline; clearing the reactor; cooling the reactor; conducting pyrophoric treatment of the reactor, the pyrophoric treatment of the reactor including: providing a buffer-passivation solution; introducing the buffer-passivation solution into the reactor; providing an oxidizer solution; introducing the oxidizer solution into the reactor; draining the reactor of the buffer-passivation solution and the oxidizer solution; and hydrogen gas purging the reactor; cooling the reactor; purging the reactor; and opening the reactor.

In some embodiments, the pyrophoric treatment of the reactor further includes: conducting a passivation operation. In some embodiments, the passivation operation includes: introducing, after hydrogen gas purging the reactor, additional buffer-passivation solution into the reactor; draining the reactor of the additional buffer-passivation solution, and hydrogen gas purging the reactor after draining the reactor of the additional buffer-passivation solution. In some embodiments, generating a buffer-passivation solution includes mixing water with a pH buffer and passivation chemical. In some embodiments, the buffer-passivation solution is injected into a hydrogen stream upstream of the reactor. In some embodiments, the oxidizer solution includes a pyrophoric oxidizer. In some embodiments, generating an oxidizer solution includes mixing water with a pyrophoric oxidizer. In some embodiments, the oxidizer solution is mixed with the buffer-passivation solution and a resulting oxidizer-passivation solution mixture is injected into a hydrogen stream upstream of the reactor. In some embodiments, the purging of the reactor includes a nitrogen gas purge of the reactor. In some embodiments, opening the reactor includes purging the reactor with atmospheric air and exposing the reactor to atmospheric pressure.

Provided in some embodiments is a method of treating a processing unit, the method including: taking a processing unit offline; clearing the processing unit; conducting pyrophoric treatment of the processing unit, the pyrophoric treatment of the processing unit including: providing a buffer-passivation solution; introducing the buffer-passivation solution into the processing unit; providing an oxidizer solution; introducing the oxidizer solution into the processing unit; draining the processing unit of the buffer-passivation solution and the oxidizer solution; and purging the processing unit with nonaqueous, dry gas; purging the processing unit; and opening the processing unit.

In some embodiments, the pyrophoric treatment of the processing unit further includes: conducting a passivation operation. In some embodiments, the passivation operation includes: introducing, after gas purging the processing unit, additional buffer-passivation solution into the processing unit; draining the processing unit of the additional buffer-passivation solution, and hydrogen gas purging the processing unit after draining the processing unit of the additional buffer-passivation solution. In some embodiments, providing a buffer-passivation solution includes providing a mixture of water, a pH buffer, and a passivation chemical. In some embodiments, the buffer-passivation solution is injected into a hydrogen stream upstream of the processing unit. In some embodiments, the oxidizer solution includes a pyrophoric oxidizer. In some embodiments, providing an oxidizer solution includes providing a mixture of water and a pyrophoric oxidizer. In some embodiments, the oxidizer solution is mixed with the buffer-passivation solution and a resulting oxidizer-passivation solution mixture is injected into a hydrogen stream upstream of the processing unit. In some embodiments, the purging of the processing unit includes an inert gas purge of the processing unit. In some embodiments, opening the processing unit includes purging the processing unit with atmospheric air and exposing the processing unit to atmospheric pressure.

Provided in some embodiments is a method of treating a reactor including: conducting pyrophoric treatment of a reactor, the pyrophoric treatment of the reactor including: providing a buffer-passivation solution; introducing a buffer-passivation solution into the reactor; providing an oxidizer solution; introducing an oxidizer solution into the reactor; draining the reactor of the buffer-passivation solution and the oxidizer solution; and dry gas purging the reactor.

In some embodiments, the reactor is taken offline and cleared prior to the pyrophoric treatment of the reactor. In some embodiments, the pyrophoric treatment of the reactor further includes: conducting a passivation operation. In some embodiments, the passivation operation includes: introducing, after gas purging the reactor, additional buffer-passivation solution into the reactor; draining the reactor of the additional buffer-passivation solution, and hydrogen gas purging the reactor after draining the reactor of the additional buffer-passivation solution. In some embodiments, the buffer-passivation solution includes a mixture of water, pH buffer, and passivation chemical. In some embodiments, the buffer-passivation solution is injected into a hydrogen stream upstream of the reactor. In some embodiments, the oxidizer solution includes a pyrophoric oxidizer. In some embodiments, the oxidizer solution includes a mixture of water and pyrophoric oxidizer. In some embodiments, the oxidizer solution is mixed with the buffer-passivation solution and a resulting oxidizer-passivation solution mixture is injected into a hydrogen stream upstream of the reactor. In some embodiments, the dry gas purging of the reactor includes a nitrogen gas purge of the reactor. In some embodiments, opening the reactor includes purging the reactor with atmospheric air and exposing the reactor to atmospheric pressure.

### BRIEF DESCRIPTION OF THE DRAWINGS

FIG. 1 is a diagram that illustrates a reactor environment in accordance with one or more embodiments.

FIGS. 2 and 3 are flow diagrams that illustrate a reactor system treatment method in accordance with one or more embodiments.

FIG. 4 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Provided in some embodiments are techniques for treating a reactor, particularly in industrial or catalytic applications, with a focus on enhancing safety and functionality when dealing with pyrophoric materials that can spontaneously ignite upon exposure to air. For example, embodiments of treating a reactor may include taking the reactor offline, disengaging it from its operational state to start the treatment process. The reactor may then be cleared of any remaining substances or residues, preparing it for further steps. Following this, the reactor may be cooled to a suitable temperature for handling and treatment. A pyrophoric treatment may then be performed, which neutralizes pyrophoric materials within the reactor to prevent spontaneous ignition. This can involve introducing a buffer-passivation solution into the reactor, which stabilizes reactive materials. An oxidizer solution may be introduced into the reactor simultaneously with (or shortly after the start of) the introduction of the buffer-passivation solution to further treat and neutralize any remaining reactive substances with a mixture of the buffer-passivation solution and the oxidizer solution. Once the buffer-passivation and oxidizer solutions have completed their function, both may be drained from the reactor. In some instances, such as when passivation is to be performed, the introduction of the oxidizer solution may be terminated, and additional buffer-passivation solution may be introduced thereafter, such that a passivation operation is completed after the introduction of the oxidizer solution. The next step may involve purging the reactor with hydrogen gas to remove any residual materials or reactive substances. The reactor may then be cooled once more to maintain a safe temperature for the final stages of the process. A second purging may be conducted to ensure the complete removal of gases or any remaining substances, and the reactor may be safely opened for inspection or maintenance. Such a technique may provide an efficient and safe process for treating reactors, particularly by neutralizing pyrophoric materials, thereby preventing hazardous reactions during maintenance or cleaning procedures.

Although certain example embodiments are described in the context of a given type of facility, configuration, or process, embodiments may be employed in any suitable context.

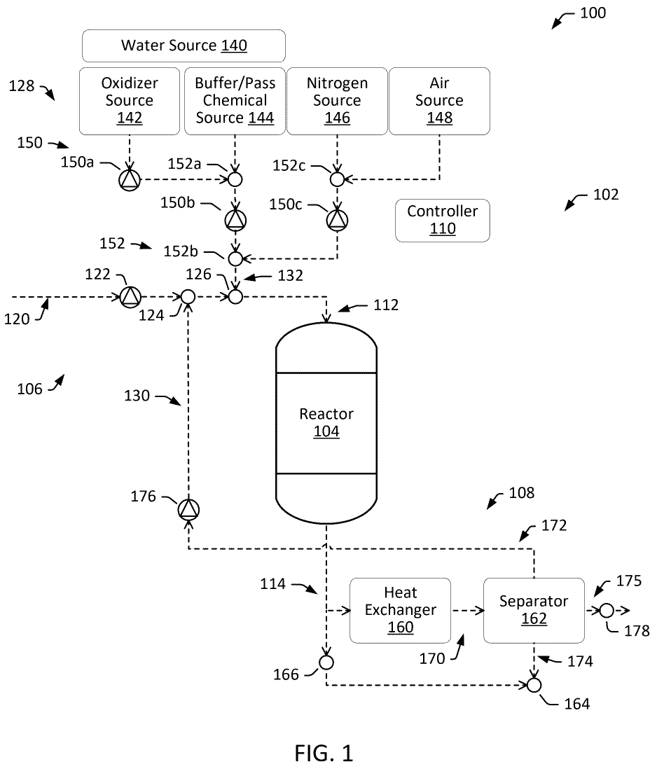

FIG. 1 is a diagram that illustrates a reactor environment 100 in accordance with one or more embodiments. In the illustrated embodiment, the reactor environment 100 includes a reactor system 102 that includes a reactor 104, a reactor input system 106, a reactor output system 108, and a reactor controller 110. The input system 106 may supply a reactor input stream 112 (e.g., including feedstock), and the reactor 104 may process components of the reactor input stream 112 and output a corresponding reactor output stream 114 (e.g., including products and other substances).

In some embodiments, the reactor 104 includes a central vessel or system where chemical reactions occur. For example, the reactor 104 may include a reactor vessel (e.g., a main containment where reactions take place), a catalyst bed (e.g., a section of catalysts that facilitate the reaction process), a heat exchanger (e.g., operable to control the temperature within the reactor), agitators (e.g., operable to mix reactants), or the like. The reactor 104 may, for example, be operated to provide for the conversion of feedstock (e.g., raw materials present in the reactor input stream 112) into desired products (e.g., materials present in the reactor output stream 114) under controlled conditions (e.g., under a given combination of temperature, pressure, catalysts, or the like). The reactor 104 may be one vessel or a series of vessels in various configurations.

In some embodiments, the reactor input system 106 provides for the delivery of the reactor input stream 112 to the reactor 104. For example, the reactor input system 106 may include feed tanks (e.g., operable to store feedstock before it is introduced into the reactor input stream 112 and the reactor 104), pumps/compressors (e.g., operable to deliver the reactor input stream 112 to the reactor, ensuring the correct flow rate and pressure), piping/conduits (e.g., operable to transport feedstock and any other required chemicals (e.g., reactants) to the reactor input stream 112 and the reactor 104), flow control valves (e.g., operable to regulate the amount of feedstock entering the reactor input stream 112 and the reactor 104), preheaters (e.g., operable to heat the reactor input stream 112 before entering the reactor), and instrumentation, such as flow meters (e.g., operable to measure the flow rate of incoming feedstock, reactants, the reactor input stream 112 or the like), temperature and pressure gauges (e.g., operable to measure the temperature and pressure of incoming feedstock, reactants, the reactor input stream 112 or the like), gas inlet systems (e.g., operable to supply gases, such as hydrogen, to facilitate the process reactions).

In the illustrated embodiment, the reactor input system 106 includes a feed stream 120, a feed pump 122, a gas feed valve 124, an injection feed valve 126, an injection system 128, and the reactor input stream 112. The feed pump 122 may, for example, be a pump operable to control the flow of the feed stream (e.g., a stream of feedstock) into the reactor input stream 112. The gas feed valve 124 may be a valve that is operable to control the flow of a gas stream 130 (e.g., a hydrogen gas stream) into the reactor input stream 112. The injection feed valve 126 may be a valve that is operable to control the flow of an injection stream 132 (e.g., an oxidizer, buffer/passivation chemical, nitrogen, air or the like) into the reactor input stream 112. The injection system 128 may be operable to control characteristics of the injection stream 132. For example, the injection system 128 may provide for the production, storage, mixing, pressurizing, heating, or the like of components that are provided in the injection stream 132. In some embodiments, the components and characteristics of the injection stream 132 are modified throughout various stages of reactor treatment. For example, certain phases of treatment of the reactor 104 may include the injection stream 132 including a cleaning agent, a buffer, a passivation chemical, an oxidizer, nitrogen, air, or the like.

In the illustrated embodiment, the injection system 128 includes a water source 140, an oxidizer source 142, a buffer/passivation chemical source 144, a nitrogen source 146, and an air source 148, injection pumps 150 (e.g., including a low pressure injection pump 150a, a high pressure injection pump 150b, and a purge pump 150c), valves 152 (e.g., a first valve 152a, a second valve 152b, and a third valve 152c). The low pressure injection pump 150a may be operable to pump an oxidizer stream to and through the first valve 152a to the high pressure injection pump 150b. The valve 152a may control the flow of the oxidizer, the buffer/passivation chemical, or a mixture thereof to the high pressure injection pump 150b. The buffer/passivation chemical may be drawn into and through the first valve 152a by a suction created by the flow of the oxidizer, the buffer/passivation chemical, or a mixture thereof through the high pressure injection pump 150b. The second valve 152b may control the flow of the output of the high pressure injection pump 150b (e.g., the oxidizer, the buffer/passivation chemical, or a mixture thereof) to and through the injection valve 126 and into the reactor input stream 112. The third valve 152c may control the flow of the nitrogen, the air, or a mixture thereof to the purge pump 150c. The nitrogen, the air, or a mixture thereof may be drawn into and through the third valve 152c by a suction created by the flow of the nitrogen, the air, or a mixture thereof through the purge pump 150c. The second valve 152b may control the flow of the output of the purge pump 150c (e.g., the nitrogen, the air, or a mixture thereof) to and through the injection valve 126 and into the reactor input stream 112.

In some embodiments, the reactor output system 108 provides for the management (e.g., routing and conditioning) of the reactor output stream 114 output by the reactor 104. For example, the reactor output system 108 may include a heat exchanger (e.g., operable to heat the reactor output stream 114), a separator (e.g., operable to divide the reactor output stream 114 into individual components, such as separating out liquids, gases, or solids based on differences in density, particle size, or chemical properties), waste systems (e.g., waste valves and drain operable to divert and drain waste products, such as effluent or the like), recycle systems (e.g., a vapor line operable to route vapor, such as hydrogen vapor output from the separator, to a gas input stream that feeds into the reactor input stream 112), and instrumentation, such as flow meters (e.g., operable to measure the flow rate of the reactor output stream 114 or the like), temperature and pressure gauges (e.g., operable to measure the temperature and pressure of the reactor output stream 114, the heated stream, separator outputs, or the like).

In the illustrated embodiment, the reactor output system 108 includes a heat exchanger 160, a separator 162, a drain 164, and a drain valve 166. The heat exchanger 160 may be operable to receive and cool the reactor output stream 114, to generate a cooled reactor output stream 170, and the cooled reactor output stream 170 may be routed into the separator 162, which divides the cooled reactor output stream 170 into individual components, including vapor and liquid, which are output into a vapor stream 172 (e.g., a hydrogen gas stream), a liquid stream 174, and a product stream 175 respectively. The vapor stream 172 may be routed to and through a compressor 176 (e.g., a hydrogen gas compressor), where it is introduced into the gas stream 130 that is fed into the reactor input stream 112 (e.g., such that the hydrogen gas vapor is recycled for use in the reactor input stream 112. The liquid stream 174 may be routed to the drain 164 for disposal. The drain valve 166 may be operable to route effluent or other substances of the reactor output stream 114 that build up in the lines to the drain 164 (e.g., the drain valve 166 may be located in a trap or low spot of the pipe routing the reactor output stream 114 to the heat exchanger, or in a similar trap or low spot on another line, and may be opened during a treatment to drain the system of effluent or other substances present in the reactor output stream 114 that build up in the pipe. This may be one drain or multiple drains depending on the equipment layout and design.). In some embodiments, the product stream 175 is regulated to facilitate or inhibit the flow of product out of the reactor system 102. For example, a product output valve 178 may be fully or partially opened to allow the flow of product out of the reactor system 102. The product output valve 178 may be closed to block the flow of product out of the reactor system 102, which may effectively isolate the reactor system 102 from downstream components. Although a single product stream is described for the purpose of illustration, the reactor system 102 may include multiple product streams or other outputs to downstream components.

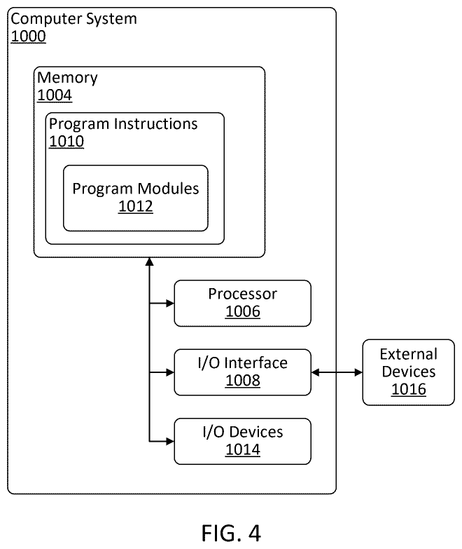

In some embodiments, the reactor controller 110 is operable to monitor or control performance of various operations of the reactor system 102. For example, the reactor controller 110 may monitor flow, pressure and temperature sensors, and control the various pumps and valves (e.g., valves 152 a-c, pumps 150a-c) to regulate the components, flowrate, temperature, or pressure of the reactor input stream 112, the reactor output stream 114, or other streams described. For example, during treatment of the reactor 104, the reactor controller 110 may monitor the flow, pressure, and temperature sensors, and control some or all of the various pumps and valves to regulate the composition of the injection stream 132 and its flow into the reactor input stream 112, as well as the composition and flow of the gas stream 130 and its flow into the reactor input stream 112, to provide an effective treatment process, such as that described herein. In some embodiments, the reactor controller 110 includes a computer system that is the same or similar to the computer system 1000 described with regard to at least FIG. 4.

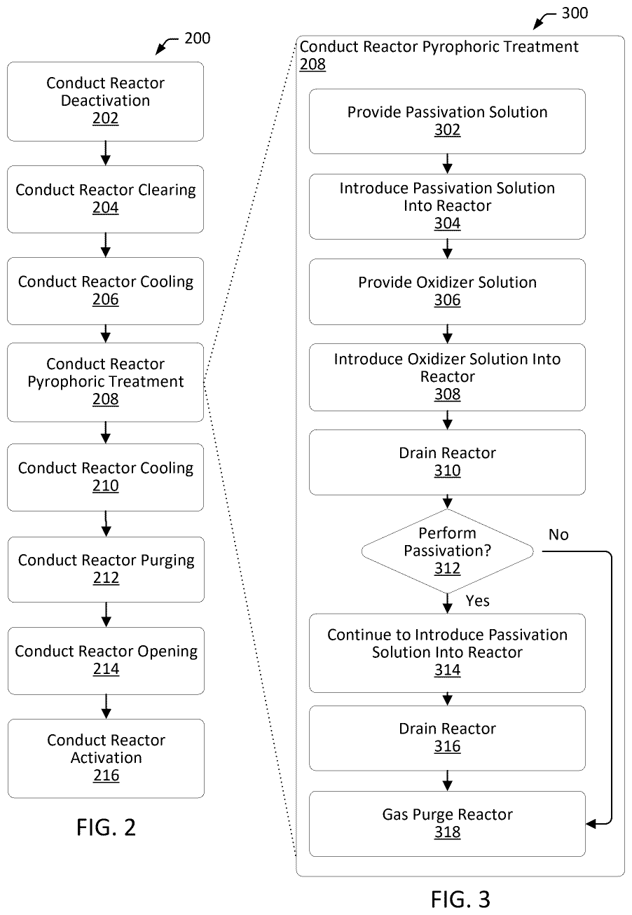

FIGS. 2 and 3 are flow diagrams that illustrate a reactor system treatment method in accordance with one or more embodiments. FIG. 2 is a flow diagram that illustrates a reactor treatment method 200 that includes a reactor pyrophoric treatment in accordance with one or more embodiments. FIG. 3 is a flow diagram that illustrates a reactor pyrophoric treatment method 300 in accordance with one or more embodiments.

Referring first to FIG. 2, in some embodiments, method 200 includes conducting reactor deactivation (block 202). This may include taking a reactor offline (or “shutting down” the reactor). For example, conducting reactor deactivation, including shutting down the reactor 104, may include stopping the feed stream and circulating a gas to expel liquids out of the reactor 104. Referencing the illustrated embodiment of FIG. 1, this may include shutting off the feed pump 122 and operating the valve 124 to block or otherwise inhibit the flow of the feed stream 120 into the reactor 104, and operating the compressor 176 and operating the valve 124 to allow or otherwise facilitate the flow of a hydrogen gas stream 130 into and through the reactor 104, the heat exchanger 160, and the separator 162, to force liquids out as a liquid stream 174 that flows to the drain 164 or another waste collection system. In such an embodiment, the hydrogen gas may exit the separator as the vapor stream 172. In some embodiments, the product stream 175 may also be shut off to block or otherwise inhibit the flow of product out of the reactor system 102, to isolate the reactor system 102 from downstream components. For example, the product output valve 178 may be closed to block the flow of product out of the reactor system 102, which may effectively isolate the reactor system 102 from downstream components. In some embodiments, the hydrogen gas stream 130 is composed of hydrogen provided from a hydrogen gas source, recycled hydrogen exiting the separator as the vapor stream 172, or a combination thereof. Thus, for example, a hydrogen source may be used to supplement recycled hydrogen gas to provide a sufficient flow of hydrogen through the reactor 104. The hydrogen gas may, for example, be circulated until fluids are sufficiently purged from the reactor system 102 (e.g., until no or minimal water is being expelled in the liquid stream 174). In some embodiments, shutting down the reactor 104 includes cooling the reactor 104. For example, shutting down the reactor 104 may include cooling the reactor 104 to a desired temperature (e.g., in the range of about 300-500 degrees Fahrenheit (°F), such as to about 400 degrees Fahrenheit). In some embodiments, cooling the reactor 104 includes passive or active cooling of the reactor 104. Passive cooling may include cooling techniques that do not require external energy or active intervention, such as pumps or fans, to cool the reactor. Instead, it may rely on natural processes such as heat dissipation through conduction, convection, or radiation. For example, in some embodiments, cooling the reactor 104 passively might involve using ambient air or surrounding environmental conditions to dissipate heat from the reactor surface without the need for circulating a coolant. Active cooling may, for example, involve circulating relatively cool substances through the reactor 104 and other components of the reactor system 102. For example, cooling the reactor system 102 actively may include circulating a relatively cool substance, such as relatively low-temperature hydrogen gas already present in the reactor, through the reactor 104 and other components of the reactor system 102 to cool them.

In some embodiments, method 200 includes conducting reactor clearing (block 204). This may include clearing the reactor of unwanted substances, such as LEL (lower explosive limit substances), H2S (hydrogen sulfide), benzene, VOCs (volatile organic compounds), gums, and like substances that cause increased pressure drop across the reactor system and/or cause loss of catalyst effectiveness. For example, conducting reactor clearing may include injection of a clearing solution to clear the reactor of unwanted substances. In some embodiments, reactor clearing includes, once the reactor 104 has cooled to a desired temperature (e.g., to 400 degrees or below), injecting a clearing solution through the reactor 104 and other components of the reactor system 102 to remove unwanted substances. In some embodiments, reactor clearing may be conducted in accordance with the process described in U.S. Pat. Nos. 10,974,239 and 11,338,280, which are hereby incorporated by reference. For example, in some embodiments, a reactor clearing may include treating a catalyst-containing reactor system 102 with a non-aqueous liquid solvent to remove contaminants (e.g., LELs, H2S, benzene, and VOCs) from the reactor 104 and other components of the reactor system 102, including the following: isolating the reactor 104 (and other components of the reactor system 102) to be treated from upstream and downstream equipment; reducing the temperature and pressure of the isolated reactor 104 (and other isolated components of the reactor system 102) by flushing with a hydrogen rich gas; injecting a non-aqueous liquid solvent into the reactor 104 (and other components of the reactor system 102) at an injection point (e.g., at valve 126 via injection stream 132) while continuously flowing hydrogen-rich gas (e.g., a hydrogen gas stream 130 injected via valve 124) through the reactor 104 (and other components of the reactor system 102); maintaining the solvent in a liquid state while flowing the solvent continuously through the reactor 104 (and other components of the reactor system 102); and terminating the step of injecting solvent and terminating the continuous flowing of hydrogen-rich gas through the reactor 104 (and other components of the reactor system 102). As a further example, reactor clearing of a catalyst-containing reactor system 102 (including the reactor 104 and other components of the reactor system 102) may include using a non-aqueous liquid solvent to remove contaminants such as LELs, H2S, benzene, VOCs, gums, and other substances that can lead to increased pressure drop or loss of catalyst effectiveness. Such a reactor clearing may begin by taking the reactor system 102 offline and isolating it from upstream and downstream equipment. Once isolated, a non-aqueous liquid solvent may be injected into the reactor system 102 at an injection point (e.g., at valve 126 via injection stream 132), allowing it to flow through the reactor system 102 (e.g., including through catalyst in a vessel of the reactor 104), while ensuring that the solvent remains in its liquid state. Simultaneously, a hydrogen-rich gas may be injected to flow through the reactor system 102 to aid in the removal of contaminants. In some embodiments, reactor clearing includes recirculating the liquid solvent continuously through the reactor system 102. Such a process may avoid the use of carrier gases containing alkanes like methane, ethane, propane, butane, or pentane. The non-aqueous solvent used may, for example, include aromatic components such as xylene or other solvents like benzene, toluene, or their chemical derivatives. In some embodiments, reactor clearing includes flushing the reactor system 102 with enough liquid solvent to cover 70% to 100% of the internal surfaces, ensuring thorough removal of contaminants. In some embodiments, before injecting the solvent, the reactor system 102 is flushed with a cutter stock or uncracked feedstock. In some embodiments, the reactor system 102 is flushed with a hydrogen-rich purge gas to cool it down before the solvent injection. Such a hydrogen flush may continue throughout the solvent injection process, and the reactor system 102 may be subsequently purged with nitrogen gas to remove any residual hydrogen. In some embodiments, reactor clearing includes dumping the catalyst under a nitrogen blanket, for example, after the treatment is complete.

In some embodiments, method 200 includes conducting reactor cooling (block 206). This may include passively or actively cooling the reactor. For example, conducting reactor cooling may include a post-reactor clearing cooling operation that includes, after completion of a reactor clearing, flowing hydrogen gas through the reactor 104 (and other components of the reactor system 102), and continuing to circulate the hydrogen gas through the reactor 104 (and other components of the reactor system 102) at a system pressure (e.g., about 450 pounds per square inch gauge (psig)) to actively cool them to a desired temperature (e.g., to less than about 200 degrees Fahrenheit, such as to about 150-200 degrees Fahrenheit, at a system pressure of about 450 psig). This may include operating various components of the reactor system 102 to circulate hydrogen (e.g., as discussed with regard to block 202).

In some embodiments, method 200 includes conducting a reactor pyrophoric treatment (block 208). This may include flowing a pyrophoric treatment solution through the reactor. For example, conducting reactor pyrophoric treatment may include, after cooling the reactor 104 (and other components of the reactor system 102) to a desired temperature, flowing a passivation solution (e.g., a buffer-passivation solution including an aqueous pH buffer solution of water, a pH buffer, and a passivation chemical) and a pyrophoric oxidizer solution (e.g., including an aqueous oxidizing solution of water and a pyrophoric oxidizer), through the reactor 104 (and other components of the reactor system 102). A reactor pyrophoric treatment may be performed as described with regard to at least method 300 of FIG. 3. For example, a reactor pyrophoric treatment may include the following: (1) injecting a passivation solution (e.g., including water, a pH buffer, and a passivation chemical) into a hydrogen stream, upstream of the reactor 104 (and other components of the reactor system 102) for a given duration; (2) subsequently injecting a pyrophoric oxidizer solution (e.g., including water and a pyrophoric oxidizer) into the hydrogen stream, upstream of the reactor 104 (and other components of the reactor system 102), where injection of the passivation solution continues such that the pyrophoric oxidizer solution is mixed and injected with the passivation solution; (3) (a) if reactor passivation is not required or otherwise to not be performed, completing the injections of the pyrophoric oxidizer solution and the passivation solution (e.g., terminating the injections of the pyrophoric oxidizer solution and the passivation solution at or near the same time), and (after completing the injections of the solutions) continuing to inject the hydrogen stream to purge the reactor 104 (and other components of the reactor system 102) of residuals of the solutions and residual water; or (b) if reactor passivation is required or otherwise to be performed, completing the injection of the pyrophoric oxidizer solution (e.g., terminating the injection of the pyrophoric oxidizer solution at a first/earlier time), (after completing the injection of the pyrophoric oxidizer solution) continuing to inject the passivation solution (e.g., such that additional passivation solution is injected after completion of the injection of the pyrophoric oxidizer solution), completing the injection of the passivation solution (e.g., terminating the injection of the passivation solution at a second/later time, such as when all of the passivation solution mixture is used), and (after completing the injection of the passivation solution) continuing to inject the hydrogen stream to purge the reactor 104 (and other components of the reactor system 102) of residuals of the solutions and residual water.

In some embodiments, method 200 includes conducting reactor cooling (block 210). This may include passively or actively cooling the reactor. For example, conducting reactor cooling may include a post-pyrophoric treatment cooling operation that includes, after completion of conducting a reactor pyrophoric treatment that includes flowing a pyrophoric oxidizer solution, a passivation solution, and hydrogen gas through the reactor 104 (and other components of the reactor system 102), continuing to flow hydrogen gas through the reactor 104 (and other components of the reactor system 102), and continuing to circulate the hydrogen gas through the reactor 104 (and other components of the reactor system 102) at a system pressure (e.g., about 450 psig) to actively cool them to a desired temperature (e.g., to less than about 120 degrees Fahrenheit, such as to about 80-150 degrees Fahrenheit, at a system pressure of about 450 pounds per square inch gauge (psig)).

In some embodiments, method 200 includes conducting reactor purging (block 212). This may include flowing an inert, nonaqueous, dry gas, such as dry nitrogen, through the reactor to purge the reactor of residual hydrogen and other flammable or noxious gases. For example, conducting reactor purging may include, after cooling the reactor 104 (and other components of the reactor system 102) with hydrogen, injecting nitrogen into and through the reactor 104 (and other components of the reactor system 102) until the residual hydrogen is at or below a LEL (lower explosive limit) of hydrogen (e.g., at or below 4% by volume in air) or levels of other substances satisfy a threshold (e.g., the level of H2S (hydrogen sulfide) is at or below a level of 1 ppm (parts per million)), or the like. For example, reactor purging may include with the feed pump 122 shut off and hydrogen flow stopped, the valve 124 blocking the flow of the feed stream 120, operating valves 152c, 152b, and 126 to route dry nitrogen gas from the nitrogen source 146 into the reactor input stream 112, and operating purge pump 150c to inject the dry nitrogen gas from the nitrogen source 146 and into the reactor input stream 112, such that the dry nitrogen gas flows through the reactor 104, the heat exchanger 160, and the separator 162 to purge hydrogen from the reactor system 102. This may be continued until the residual hydrogen or other substances are at an acceptable level. In some embodiments, the rector system 102, including the reactor 104 or other components of the rector system 102, are maintained within a temperature range, such as about 80-120° F.

In some embodiments, method 200 includes conducting reactor opening (block 214). This may include flowing a gas, such as atmospheric air, through the reactor to purge the reactor of residual nitrogen. For example, conducting reactor opening may include injecting atmospheric air into and through the reactor 104 (and other components of the reactor system 102) until any residual toxic substances are at an acceptable level. With the reactor opened, various operations can be conducted, such as reactor maintenance. For example, after conducting the reactor opening, maintenance personnel may enter the reactor 104 to remove and replace catalysts, clean the internal surfaces of the reactor 104 (and other components of the reactor system 102, such as heat exchangers), conduct inspections and repairs, or the like. For example, reactor opening may include with the feed pump 122 shut off, the valve 124 blocking the flow of the feed stream 120, operating valves 152c, 152b, and 126 to route air from the air source 148 into the reactor input stream 112, and operating purge pump 150c to inject the air from the air source 148 and into the reactor input stream 112, such that the air flows through the reactor 104, the heat exchanger 160, and the separator 162 to purge any residual toxic substances from the reactor system 102. This may be continued until the residual toxic substances are at an acceptable level.

In some embodiments, method 200 includes conducting a reactor activation (block 216). This may include bringing the reactor online (or “starting up” the reactor), including, for example, inspections, mechanical work, pressure and leak testing, gradual reintroduction of gases and feedstocks, temperature ramp-up, and close monitoring to ensure safe and efficient operation. For example, conducting reactor activation, including starting up the reactor 104, may include conducting final inspections and testing of the reactor to confirm that it is safe to resume operation of the reactor 104, re-loading catalysts, ramping-up pressure and temperature of the reactor 104 (and other components of the reactor system 102), opening the reactor input system 106 and ramping-up the process feed stream 120 (e.g., including feedstock) and gas feed stream 130 (e.g., including hydrogen), and monitoring operation and production of the reactor 104.

Referring to FIG. 3, in some embodiments, conducting a reactor pyrophoric treatment (e.g., at block 208) includes providing a passivation solution (block 302). This may include mixing or otherwise preparing a passivation solution, such as an aqueous pH buffer solution that is a mixture of water, a pH buffer, and a passivation chemical. For example, providing a passivation solution may include mixing, on-site (e.g., at or near the reactor system 102), low-chloride water (e.g., less than 0.025% chloride by weight concentration) from water source 140 (e.g., a water frac tank) with a premixed powder blend of pH buffer and a passivation chemical provided from the buffer/passivation chemical source 144. The premixed powder blend may, for example, include 80% sodium carbonate (soda ash), 13.3% sodium nitrate, and 6.7% surfactant (e.g., either 9 N9 type nonylphenol ethoxylate or TSP (trisodium phosphate)). The mixed passivation solution may have a relatively high pH (e.g., a pH of about 9 or higher), which may remain relatively stable over time. The total volume of the passivation solution may be equivalent to the empty volume of the reactor vessels. The mixing may include heating of the water or the mixture to facilitate dissolving of powder into the water.

In some embodiments, conducting a reactor pyrophoric treatment includes introducing a passivation solution into a reactor (block 304). This may include injecting a passivation solution (e.g., including a mixture of water, a pH buffer, and a passivation chemical) into a hydrogen stream, upstream of the reactor. For example, introducing a passivation solution into a reactor may include shutting off the feed pump 122, operating valve 124 to block the flow of the feed stream 120 and enable the flow of the hydrogen gas stream 130 through valve 124, operating valves 152a, 152b, and 126, and the injection pump 150b, to inject the mixed passivation solution (e.g., the injection stream 132 including the mixture of low-chloride water, the pH buffer, and the passivation chemical) into the hydrogen gas stream 130, upstream of the reactor 104, such that a reactor input stream 112 includes a mixture of the passivation solution and hydrogen gas that is flowed through the reactor 104, the heat exchanger 160, and the separator 162, where liquid is directed to the drain 164 and hydrogen vapor 172 is directed to the compressor 176 for recycling back into the reactor system via the hydrogen gas stream 130. In some embodiments, the injection of the passivation solution is conducted for a given duration of time (e.g., for a minimum of about 2 hours).

In some embodiments, conducting a reactor pyrophoric treatment includes providing an oxidizer solution (block 306). This may include mixing or otherwise preparing a pyrophoric oxidizer solution, such as an aqueous oxidizing solution that is a mixture of water and a pyrophoric oxidizer. For example, providing an oxidizer solution may include mixing, on-site (e.g., at or near the reactor system 102), low-chloride water (e.g., 0.025% chloride by weight concentration) from water source 140 (e.g., a water frac tank) with a peroxymonosulfate (monopersulfate) solid powder provided from the oxidizer source 142. The mixture may, for example, include about two pounds of powder per gallon of water. The mixed oxidizer solution may have a relatively low pH (e.g., a pH in the range of about 2-4), which may degrade over time. Some of the mixed passivation solution may be added to the mixed oxidizer solution to increase the pH closer to a neutral pH; however, the pH may be maintained to keep the solution acidic until injection. The total weight and volume of the oxidizer solution may be of a predetermined amount for the treatment.

In some embodiments, conducting a reactor pyrophoric treatment includes introducing an oxidizer solution into a reactor (block 308). This may include injecting an oxidizer solution (e.g., including a mixture of water and a pyrophoric oxidizer) into a hydrogen stream, upstream of the reactor. In some embodiments, the oxidizer solution is introduced simultaneously with a passivation solution, so that a mixture of oxidizer solution and a passivation solution (and any injected hydrogen gas) is flowed through the reactor. Continuing with the prior example, introducing an oxidizer solution into a reactor may include, with the feed pump 122 shut off, the valve 124 blocking the flow of the feed stream 120 and enabling the flow of the hydrogen gas stream 130 through valve 124, and valves 152a, 152b, and 126, and the injection pump 150b operating to inject the mixed passivation solution (e.g., including the mixture of low-chloride water, the pH buffer, and the passivation chemical) into the hydrogen gas stream 130, upstream of the reactor 104, the valve 152a may be operated to allow the oxidizer solution to mix with the flow of passivation chemical to the injection pump 150b, and the injection pump 150a may be operated to inject the oxidizer solution into the valve 152a, to cause it to mix with the passivation solution, creating a passivation/oxidizer solution (e.g., a mixture of the passivation solution and the oxidizer solution) that is drawn into and through the operating injection pump 150b, which further pressurizes the passivation/oxidizer solution and injects it through the valve 152 and valve 126, where it mixes with the hydrogen gas stream to create a reactor input stream 112 that is a mixture of the passivation solution, the oxidizer solution, and hydrogen gas that is flowed through the reactor 104, the heat exchanger 160 and the separator 162, where liquid is directed to the drain 164 and hydrogen vapor 172 is directed to the compressor 176 for recycling in the hydrogen gas stream 130. In some embodiments, the injection of the oxidizer solution is conducted for a given duration of time (e.g., for a minimum of about 1 hour).

In some embodiments, conducting a reactor pyrophoric treatment includes draining a reactor (block 310). This may include draining residual fluids and checking the fluid for appropriate characteristics. For example, this may include draining fluids from valve 166, heat exchanger 160, or the liquid output of separator 162, and checking the pH, ORP, content of chlorides or the like, to ensure that they are acceptable. Where, for example, the passivation solution is injected without the oxidizer solution, acceptable residual fluid characteristics may include a pH of about 9 or greater or chlorides of about 250 ppm or less. Where, for example, the passivation/oxidizer solution is injected, acceptable residual fluid characteristics may include a pH of about 5-7. Where, for example, the oxidizer solution is injected (without the passivation solution), acceptable residual fluid characteristics may include a pH of about 2-4. If the residual fluid characteristics are not acceptable, remedial actions may be taken, such as continuing to inject the passivation solution, the passivation/oxidizer solution, or the oxidizer solution, until the residual fluid characteristics are acceptable.

In some embodiments, conducting a reactor pyrophoric treatment includes determining whether passivation is to be performed for a reactor (block 312). This may include determining, when developing parameters for the reactor pyrophoric treatment or during the reactor pyrophoric treatment, whether passivation is to be completed for the reactor. Such a determination may be made, for example, based on known characteristics of the reactor (e.g., before the reactor treatment process is started) or based on results and measurements observed during treatment of the reactor (e.g., during the reactor treatment process if the treatment process reveals a need for the treatment).

In some embodiments, where passivation is not to be performed for a reactor, conducting reactor pyrophoric treatment may include completing the introduction of the passivation solution and the oxidizer solution, and proceeding to conduct a gas purge of the reactor (block 318). This may include circulating hydrogen gas through the reactor until fluids are sufficiently purged from the reactor system 102 (e.g., until no or minimal water is being expelled in the liquid stream 174). Continuing with the prior example, this may include with the feed pump 122 shut off, the valve 124 blocking the flow of the feed stream 120 and enabling the flow of the hydrogen gas stream 130 through valve 124, operating valves 152a, 152b, and 126 to inhibit the flow of the injection stream 132 into the reactor input stream 112, and shutting off the injection pumps 150a and 150b, and continuing to operate the compressor 176 (and supplement with an external hydrogen source as needed) to continue to circulate the hydrogen of the hydrogen gas stream 130 through the reactor 104, the heat exchanger 160 and the separator 162. The liquid stream 174 may be monitored, and the purge may be conducted until the liquid stream 174 has less than a threshold rate of liquid output. In some embodiments, after the gas purge, the method may proceed to conducting reactor cooling (e.g., at block 210), and so forth.

In some embodiments, where passivation is to be performed for a reactor, conducting reactor pyrophoric treatment may include completing the introduction of the oxidizer solution, and continuing to introduce the passivation solution into the reactor (block 314). This may include, where a passivation/oxidizer solution is being injected, including injection of the passivation solution in parallel with injection of the oxidizer solution, terminating injection of the oxidizer solution and continuing with injection of the passivation solution. Continuing with the prior example, introducing an oxidizer solution into a reactor may include, with the feed pump 122 shut off, the valve 124 blocking the flow of the feed stream 120 and enabling the flow of the hydrogen gas stream 130 through valve 124, and valves 152a, 152b, and 126, and the injection pump 150b operating to inject the mixed passivation solution (e.g., including the mixture of low-chloride water, the pH buffer, and the passivation chemical) into the hydrogen gas stream 130, upstream of the reactor 104, operating the valve 152a to block or otherwise inhibit the oxidizer solution mixing with the flow of passivation chemical to the injection pump 150b and shutting down the injection pump 150a to cease mixing of the oxidizer solution with the passivation solution, such that the passivation solution continues to be injected through the valve 152b and the injection valve 126, where it mixes with the hydrogen gas stream to create a reactor input stream 112 that is a mixture of the passivation solution and hydrogen gas that is flowed through the reactor 104, the heat exchanger 160, and the separator 162, where liquid is directed to the drain 164 and hydrogen vapor 172 is directed to the compressor 176 for recycling in the hydrogen gas stream 130. In some embodiments, the injection of the passivation solution is conducted for a given duration of time (e.g., for a minimum of about 30 minutes).

In some embodiments, conducting a reactor pyrophoric treatment includes draining a reactor (after conducting a passivation operation, e.g., that includes continuing to introduce the passivation solution into the reactor) (block 316). This may include draining residual fluids and checking the fluid for appropriate characteristics. For example, this may include draining fluids from valve 166, heat exchanger 160, or the liquid output of separator 162, and checking the pH, content of chlorides or the like, to ensure that they are acceptable. Where, for example, the passivation solution is injected without the oxidizer solution, such as during the passivation operation, acceptable residual fluid characteristics may include a pH of about 9 or greater or chlorides of about 250 ppm or less. If the residual fluid characteristics are not acceptable, remedial actions may be taken, such as continuing to inject the passivation solution until the residual fluid characteristics are acceptable.

In such an embodiment, where passivation is performed for a reactor, conducting reactor pyrophoric treatment may include completing the introduction of the passivation solution (and associated draining) and proceeding to conduct a gas purge of the reactor (block 318). This may include circulating hydrogen gas through the reactor until fluids are sufficiently purged from the reactor system 102 (e.g., until no or minimal water is being expelled in the liquid stream 174). Continuing with the prior example, this may include with the feed pump 122 shut off, the valve 124 blocking the flow of the feed stream 120 and enabling the flow of the hydrogen gas stream 130 through valve 124, operating valves 152a, 152b, and 126 to inhibit the flow of the injection stream 132 into the reactor input stream 112, shutting off the injection pump 150b (with the injection pump 150a remaining shut off following the termination of the oxidizer solution injection), and continuing to operate the compressor 176 (and supplement with an external hydrogen source as needed) to continue to circulate the hydrogen of the hydrogen gas stream 130 through the reactor 104, the heat exchanger 160, and the separator 162. The liquid stream 174 may be monitored, and the purge may be conducted until the liquid stream 174 has less than a threshold rate of liquid output. In some embodiments, after the gas purge, the method may proceed to conducting reactor cooling (e.g., at block 210), and so forth.

FIG. 4 is a diagram that illustrates an example computer system (or “system”) 1000 in accordance with one or more embodiments. The system 1000 may include a memory 1004, a processor 1006, and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the operation of the reactor system 102 (and the treatment of reactor 104), method 200, or method 300.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers, or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method of treating a reactor comprising:
taking a reactor offline;
clearing the reactor;
cooling the reactor;
conducting pyrophoric treatment of the reactor, the pyrophoric treatment of the reactor comprising:
providing a buffer-passivation solution;
introducing the buffer-passivation solution into the reactor;
providing an oxidizer solution;
introducing the oxidizer solution into the reactor;
draining the reactor of the buffer-passivation solution and the oxidizer solution; and
hydrogen gas purging the reactor;
cooling the reactor;
purging the reactor; and
opening the reactor.

2. The method of claim 1, wherein the pyrophoric treatment of the reactor further comprises:
conducting a passivation operation.

3. The method of claim 2, wherein the passivation operation comprises:
introducing, after hydrogen gas purging the reactor, additional buffer-passivation solution into the reactor;
draining the reactor of the additional buffer-passivation solution, and
hydrogen gas purging the reactor after draining the reactor of the additional buffer-passivation solution.

4. The method of claim 1, wherein generating a buffer-passivation solution comprises mixing water with a pH buffer and passivation chemical.

5. The method of claim 1, wherein the buffer-passivation solution is injected into a hydrogen stream upstream of the reactor.

6. The method of claim 1, wherein the oxidizer solution comprises a pyrophoric oxidizer.

7. The method of claim 1, wherein generating an oxidizer solution comprises mixing water with a pyrophoric oxidizer.

8. The method of claim 1, wherein the oxidizer solution is mixed with the buffer-passivation solution and a resulting oxidizer-passivation solution mixture is injected into a hydrogen stream upstream of the reactor.

9. The method of claim 1, wherein the purging of the reactor comprises a nitrogen gas purge of the reactor.

10. The method of claim 1, wherein opening the reactor comprises purging the reactor with atmospheric air and exposing the reactor to atmospheric pressure.

11. A method of treating a processing unit, the method comprising:
taking a processing unit offline;
clearing the processing unit;
conducting pyrophoric treatment of the processing unit, the pyrophoric treatment of the processing unit comprising:
providing a buffer-passivation solution;
introducing the buffer-passivation solution into the processing unit;
providing an oxidizer solution;
introducing the oxidizer solution into the processing unit;
draining the processing unit of the buffer-passivation solution and the oxidizer solution; and
purging the processing unit with nonaqueous, dry gas;
purging the processing unit; and
opening the processing unit.

12. The method of claim 11, wherein the pyrophoric treatment of the processing unit further comprises:
conducting a passivation operation.

13. The method of claim 12, wherein the passivation operation comprises:
introducing, after gas purging the processing unit, additional buffer-passivation solution into the processing unit;
draining the processing unit of the additional buffer-passivation solution, and
hydrogen gas purging the processing unit after draining the processing unit of the additional buffer-passivation solution.

14. The method of claim 11, wherein providing a buffer-passivation solution comprises providing a mixture of water, a pH buffer, and a passivation chemical.

15. The method of claim 11, wherein the buffer-passivation solution is injected into a hydrogen stream upstream of the processing unit.

16. The method of claim 11, wherein the oxidizer solution comprises a pyrophoric oxidizer.

17. The method of claim 11, wherein providing an oxidizer solution comprises providing a mixture of water and a pyrophoric oxidizer.

18. The method of claim 11, wherein the oxidizer solution is mixed with the buffer-passivation solution and a resulting oxidizer-passivation solution mixture is injected into a hydrogen stream upstream of the processing unit.

19. The method of claim 11, wherein the purging of the processing unit comprises an inert gas purge of the processing unit.

20. The method of claim 11, wherein opening the processing unit comprises purging the processing unit with atmospheric air and exposing the processing unit to atmospheric pressure.

21. A method of treating a reactor comprising:
conducting pyrophoric treatment of a reactor, the pyrophoric treatment of the reactor comprising:
providing a buffer-passivation solution;
introducing a buffer-passivation solution into the reactor;
providing an oxidizer solution;
introducing an oxidizer solution into the reactor;
draining the reactor of the buffer-passivation solution and the oxidizer solution; and
dry gas purging the reactor.

22. The method of claim 21, wherein the reactor is taken offline and cleared prior to the pyrophoric treatment of the reactor.

23. The method of claim 21, wherein the pyrophoric treatment of the reactor further comprises:
conducting a passivation operation.

24. The method of claim 23, wherein the passivation operation comprises:
introducing, after gas purging the reactor, additional buffer-passivation solution into the reactor;
draining the reactor of the additional buffer-passivation solution, and
hydrogen gas purging the reactor after draining the reactor of the additional buffer-passivation solution.

25. The method of claim 21, wherein the buffer-passivation solution comprises a mixture of water, pH buffer, and passivation chemical.

26. The method of claim 21, wherein the buffer-passivation solution is injected into a hydrogen stream upstream of the reactor.

27. The method of claim 21, wherein the oxidizer solution comprises a pyrophoric oxidizer.

28. The method of claim 21, wherein the oxidizer solution comprises a mixture of water and pyrophoric oxidizer.

29. The method of claim 21, wherein the oxidizer solution is mixed with the buffer-passivation solution and a resulting oxidizer-passivation solution mixture is injected into a hydrogen stream upstream of the reactor.

30. The method of claim 21, wherein the dry gas purging of the reactor comprises a nitrogen gas purge of the reactor.

31. The method of claim 21, wherein opening the reactor comprises purging the reactor with atmospheric air and exposing the reactor to atmospheric pressure.
